(19) United States
(12) Patent Application Publication
(10) Pub. No.: US 2010/0254625 A1
(43) Pub. Date: Oct. 7, 2010

(54) Creed Triangle Gridding Method

(76) Inventor: Nathan James Creed, Bridgewater, MA (US)

Correspondence Address: Nathan James Creed, 1506 E 153rd Street, Olathe, KS, 66062, US

(21) Appl. No.: 12/398,223

(22) Filed: Apr. 1, 2009

(51) Int. Cl. G06K 9/36

(52) U.S. Cl. 382/276

(57) ABSTRACT

A method has been created, which does not require measuring or mathematical calculations, that accurately segregates the medium into manageable parts, thereby allowing the user to readily duplicate, enlarge, reduce, or skew images.

### CROSS-REFERENCE TO RELATED ITEMS

The Creed Triangle Grid can look similar to triangle, triangle-square, and isometric grids. However, it provides a specific and detailed method of gridding using both triangular and rectangular forms. The Creed Triangle Grid Method can be modified to adapt to specific purposes, especially pertaining to the creation or modification of art. The Creed Triangle Gridding Method can also look similar to the Coarsest Grid used in mathematics.

### STATEMENT REGARDING FEDERALLY SPONSORED RESEARCH OR DEVELOPMENT

N/A

### REFERENCE TO SEQUENCE LISTING A TABLE OR A COMPUTER PROGRAM LISTING COMPACT DISC APPENDIX

N/A

### BACKGROUND OF THE INVENTION

The invention pertains to the following fields: (1) to aid with teaching people how to draw; (2) to assist with the authorized duplication of existing works of art; and (3) to help improve drawing techniques. The existing style of gridding that is commonly used in art is a square grid. This can be problematic because the measurements of the grid must exactly match the measurements of the picture associated with it in order to be effective. In contrast, the Creed Triangle Gridding Method does not require precise measurements to be effective. It utilizes triangles combined with squares to become more adaptable and detail-oriented than a square grid. The combination of the triangle and square elements in this grid allows the user to narrow in on certain parts of an image, place less focus on certain parts of an image, or selectively shrink or enlarge certain parts of an image without having to spend time measuring out a square grid that precisely corresponds to the image. With The Creed Triangle Gridding Method, drawings can more easily be enlarged or copied on media that is a different size than the original work. The Creed Triangle Gridding Method also greatly reduces the time needed to copy, enlarge, reduce, or skew existing works onto new media.

### BRIEF SUMMARY OF THE INVENTION

The Creed Triangle Gridding Method is a form of gridding used to duplicate, enlarge, reduce, or skew images without measuring. It uses a grid of triangles, rather than squares, and therefore provides the user with an adaptable method of gridding. This personalized form of gridding allows the user to focus on specific areas of a composition or change the composition however they wish. This gridding method also provides users with a user-friendly and personalized way to alter or create pieces of art, mathematical functions, architectural features, or any other creation they wish.

### BRIEF DESCRIPTION OF THE SEVERAL VIEWS OF THE DRAWING

FIG. 1: The user first places a line from one corner of the medium to the opposite corner.

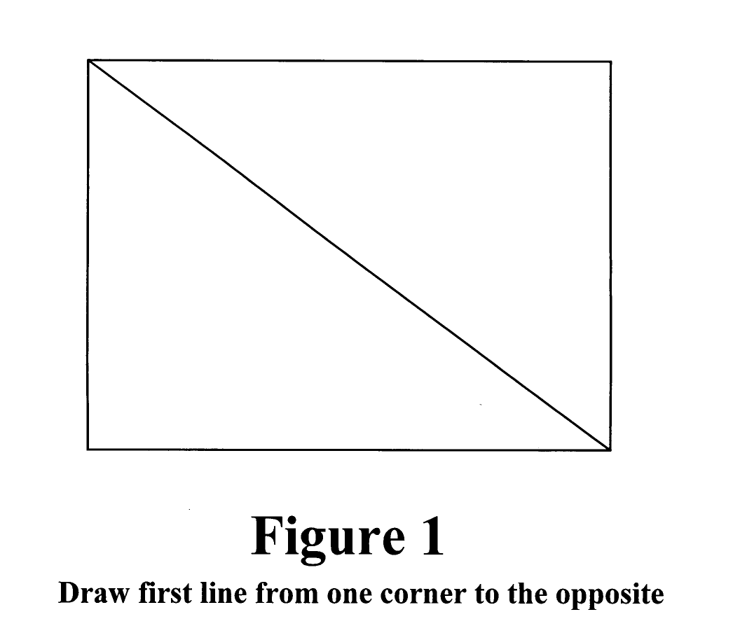

FIG. 2: The user then places a line from the other corner of the medium to its opposite corner. The medium is now divided by a saltire “X”.

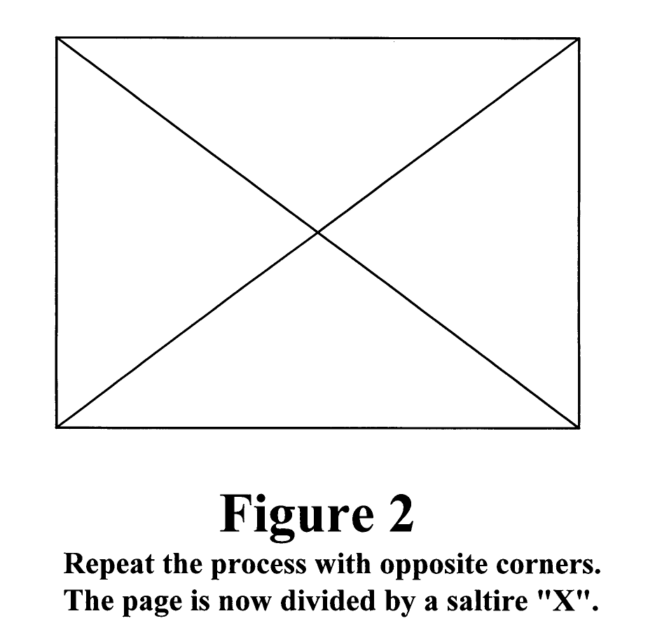

FIG. 3: The user next places a vertical line through the center of the saltire.

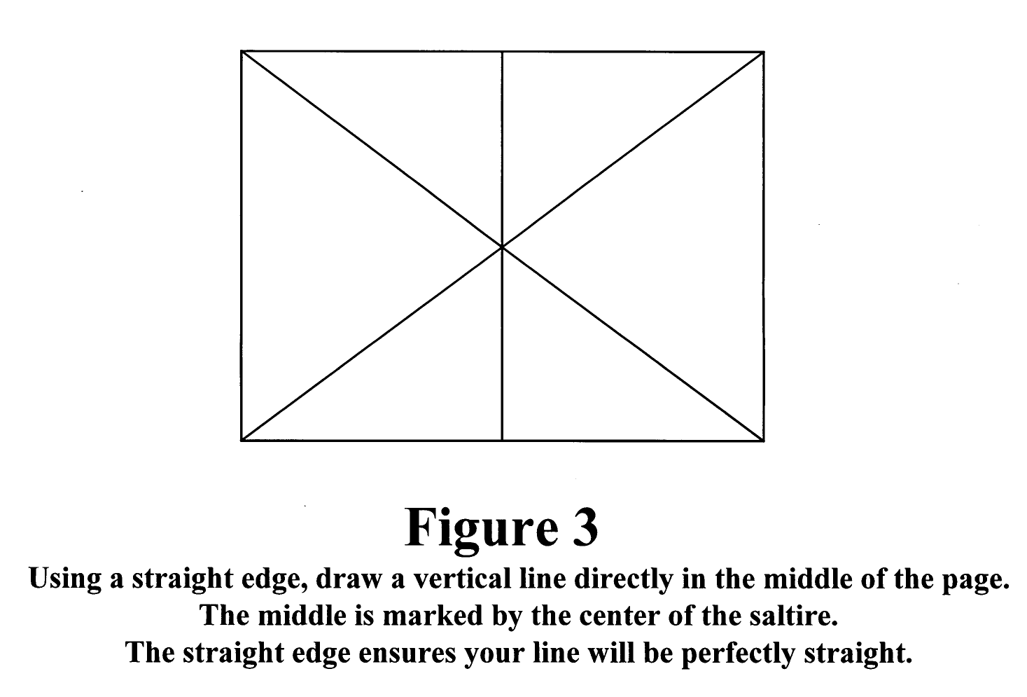

FIG. 4: Next, the user places a horizontal line through the intersection point located in the center of the medium.

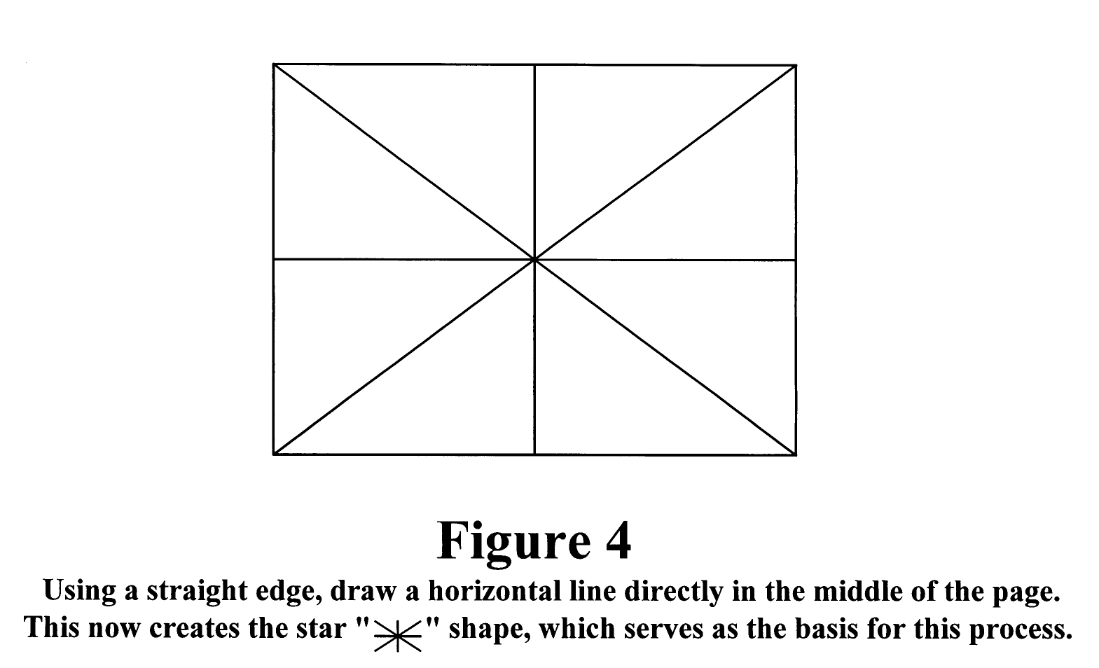

FIG. 5: Depicts the medium divided into quadrants, each quadrant being divided in half.

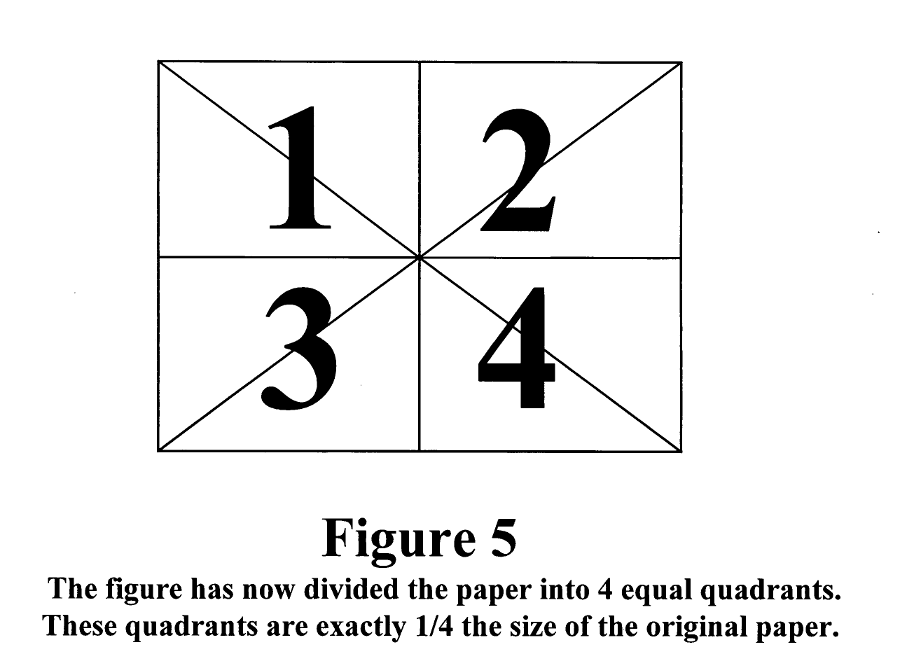

FIG. 6: Depicts how the The Creed Triangle Gridding Method can be repeated within any, or all, of the quadrants. The need to repeat this method would depend on where in the medium there are details requiring further division. This figure shows how the medium could be divided into 32 separate sectors.

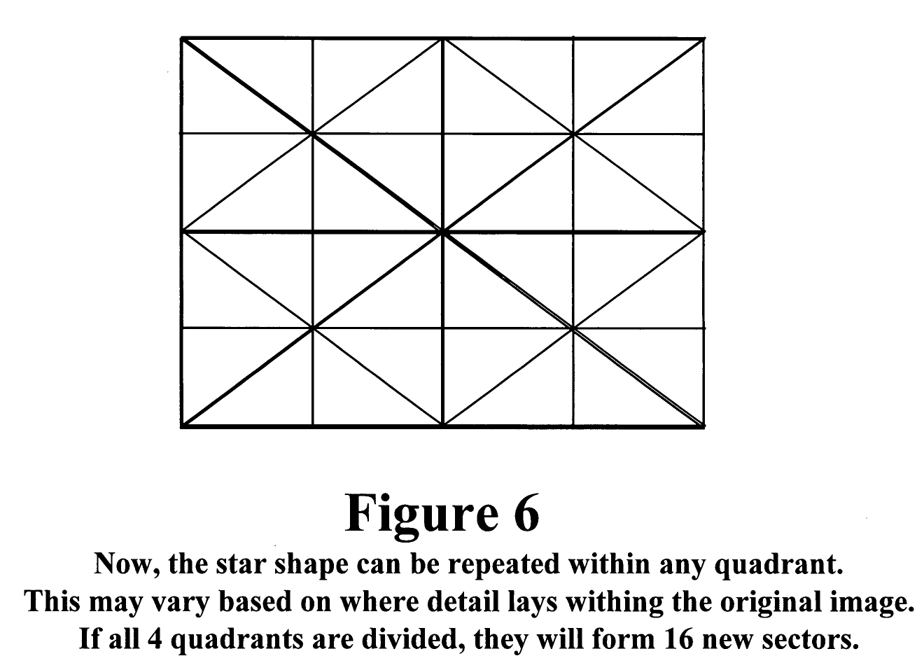

FIG. 7: Depicts how the grid can further be divided by repeating the method is any sector.

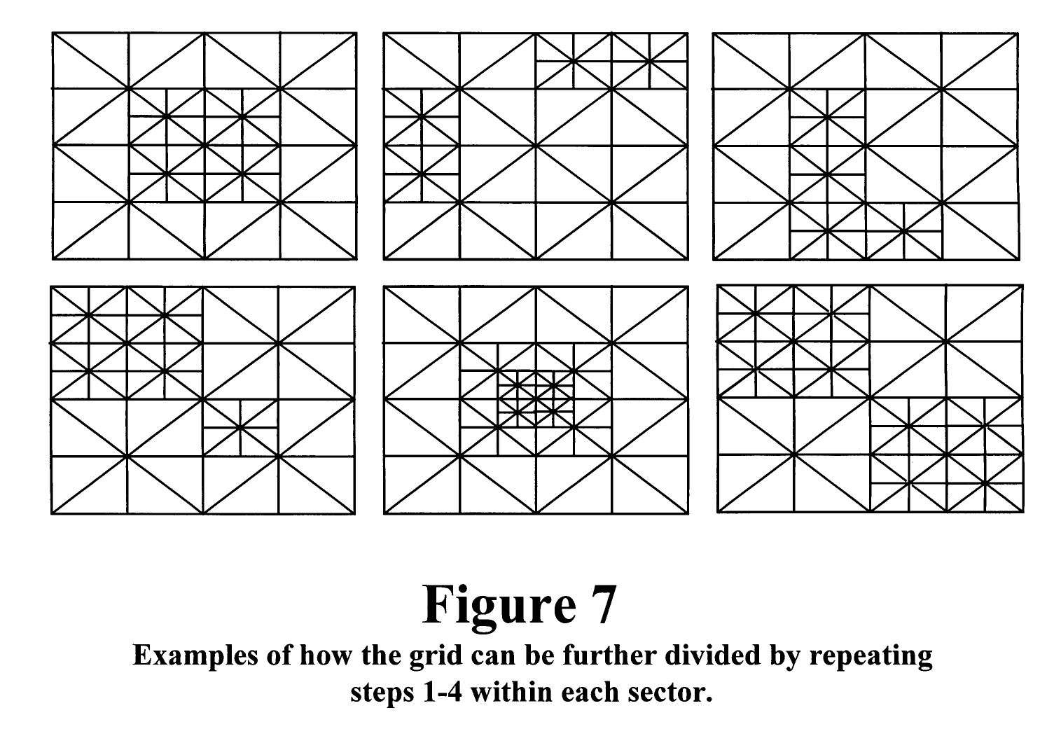

FIG. 8: Depicts how The Creed Triangle Gridding Method can be used to duplicate images.

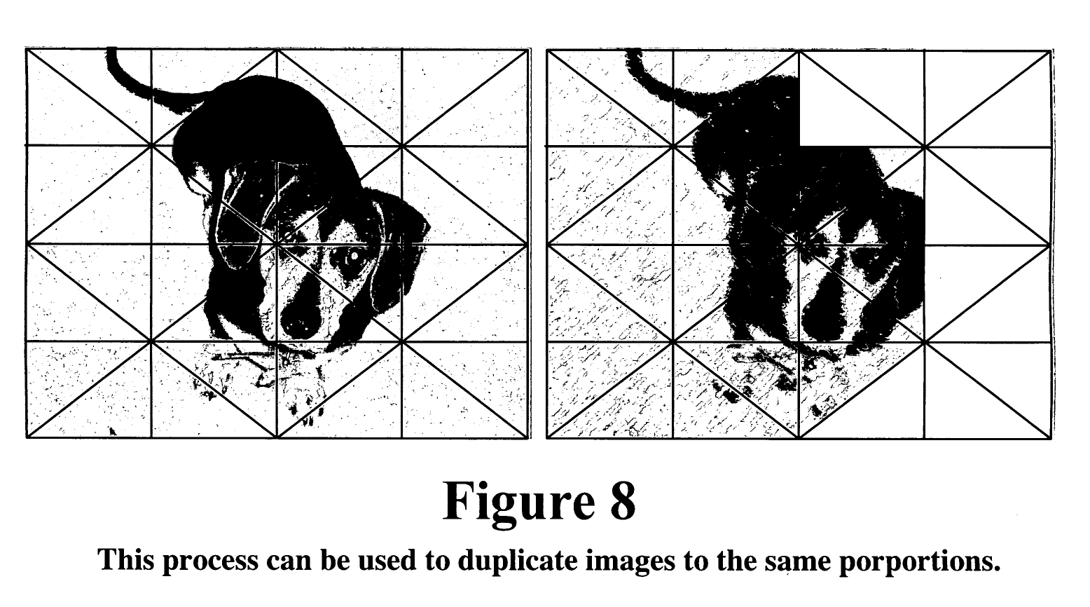

FIG. 9: Depicts how The Creed Triangle Gridding Method can be used to enlarge images.

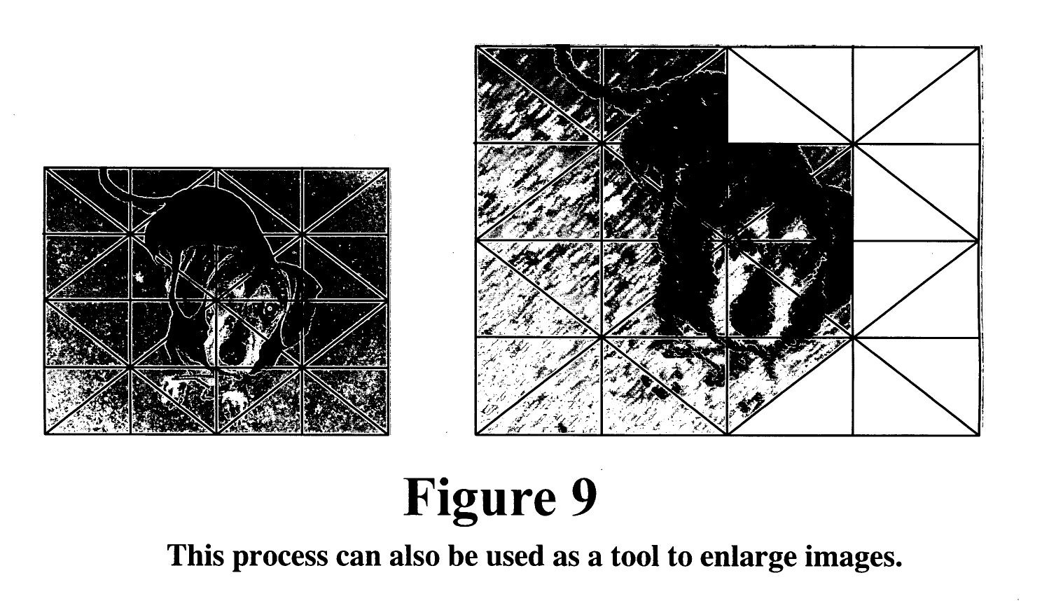

FIG. 10: Depicts how The Creed Triangle Gridding Method can be used to skew an image (note that although the image is skewed, the subject appears natural).

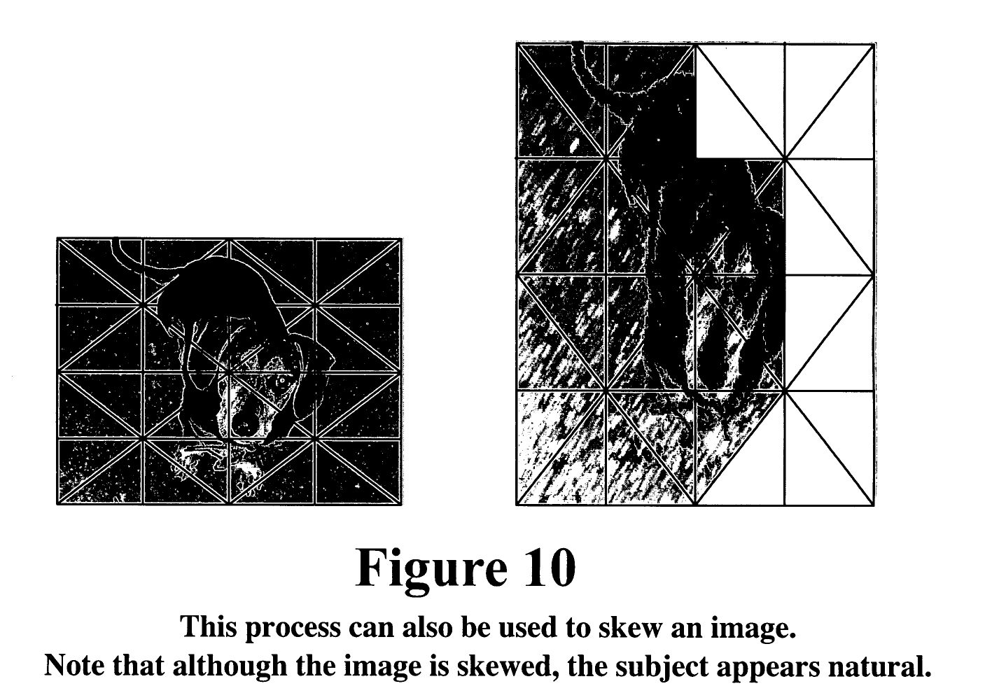

### DETAILED DESCRIPTION OF THE INVENTION

The Creed Triangle Gridding Method is a form of gridding used to duplicate, enlarge, reduce, or skew images without measuring. The Creed Triangle Gridding Method is applied by first drawing opposite and intersecting diagonal lines across the page, from corner to corner, forming a large saltire “X”. Next, the user draws a set of perpendicular vertical and horizontal lines on top of the existing diagonal lines, thereby intersection in the center of the crossed diagonal lines. This creates four identical quadrants (top left, top right, bottom left and bottom right). In each quadrant, the user, as desired, can repeat the method to segregate each quadrant into repetitively smaller sectors. The method may be concentrated in only specific areas of the page, depending on the amount of detail in the image being duplicated, or simply used as a tool to enlarge, shrink, or skew the image.

1. A method used to accurately and easily duplicate, enlarge, reduce, or skew images.
